(19) United States
(12) Patent Application Publication
(10) Pub. No.: US 2026/0170615 A1
(43) Pub. Date: Jun. 18, 2026

(54) ELECTRONIC DEVICE FOR REMOVING NOISE WHEN RENDERING IMAGES AND OPERATION METHOD THEREOF

(71) Applicants: SAMSUNG ELECTRONICS CO., LTD., Suwon-si (KR); GWANGJU INSTITUTE OF SCIENCE AND TECHNOLOGY, Gwangju (KR)

(72) Inventors: Bochang MOON, Gwangju (KR); Hajin Choi, Gwangju (KR)

(73) Assignees: SAMSUNG ELECTRONICS CO., LTD., Suwon-si (KR); GWANGJU INSTITUTE OF SCIENCE AND TECHNOLOGY, Gwangju (KR)

(21) Appl. No.: 19/210,602

(22) Filed: May 16, 2025

(30) Foreign Application Priority Data
Dec. 18, 2024 (KR) 10-2024-0189887

(51) Int. Cl. G06T 5/60; G06T 5/70

(52) U.S. Cl. CPC G06T 5/60; G06T 5/70

(57) ABSTRACT

An electronic device for removing noise when rendering images and an operation method thereof are provided. The operation method may include generating, based on a view point of a current frame, a first image, a second image, and geometry (G)-buffer images; generating, based on a relationship between the first image and the second image, a first intermediate image and a second intermediate image, from which a portion of noise in the first image and the second image is removed, respectively; determining bandwidth parameters by inputting, to an artificial neural network, the first intermediate image, the second intermediate image, the G-buffer images, and a reprojected image obtained when an output image of a previous frame is reprojected, and generating, using a first filter and a second filter to which the bandwidth parameters are applied, a target image by removing noise from the first intermediate image and the second intermediate image.

### CROSS-REFERENCE TO RELATED APPLICATION

This application claims priority from Korean Patent Application No. 10-2024-0189887, filed on Dec. 18, 2024, in the Korean Intellectual Property Office, the disclosure of which is incorporated by reference herein in its entirety.

### BACKGROUND

### 1. Field

Methods and apparatuses consistent with embodiments of the disclosure relate to an electronic device for removing noise when rendering images and an operation method thereof.

### 2. Description of the Related Art

When rendering is performed on an image sequence that includes various lighting effects, ray tracing technology may be utilized. The ray tracing technology may be a rendering technique that physically simulates a path of light to generate realistic lighting, shadow, and reflection effects. The ray tracing technology may provide high-quality images by tracing virtual rays from each pixel and calculating interactions with objects in a scene.

### SUMMARY

One or more embodiments may address at least the problems and/or disadvantages described above, and other disadvantages not described above. Also, the embodiments are not required to overcome and may not overcome any of the problems and disadvantages described above.

According to an aspect of an example embodiment of the disclosure, there is provided an operation method of an electronic device, the operation method including: generating, based on a view point of a current frame, a first image, a second image, and at least one geometry (G)-buffer image; determining, based on the first image, the second image, and the at least one G-buffer image, a relationship between the first image and the second image; generating, based on the relationship, a first intermediate image and a second intermediate image, from which a portion of a noise in the first image and the second image is removed, respectively; determining bandwidth parameters of a filter for removing a noise from the first intermediate image and the second intermediate image by inputting, to an artificial neural network, the first intermediate image, the second intermediate image, the at least one G-buffer image, and a reprojected image obtained when an output image of a previous frame of the current frame is reprojected from the view point of the current frame; and generating a target image, which is an output image of the current frame, by removing the noise from the first intermediate image and the second intermediate image using the filter to which the bandwidth parameters are applied.

The determining the relationship may include determining a first relationship between a pixel value of the first image and pixel variables of the second image and determining a second relationship between a pixel value of the second image and pixel variables of the first image.

The first relationship and the second relationship may be expressed linearly.

The first image and the at least one G-buffer image may be images generated from the view point of the current frame, and the second image may be an image generated from the view point of the current frame or a view point of the previous frame.

The determining the bandwidth parameters may include: downsampling the first intermediate image, the second intermediate image, the at least one G-buffer image, and the reprojected image and inputting, to the artificial neural network, the downsampled first intermediate image, the downsampled second intermediate image, the downsampled at least one G-buffer image, and the downsampled reprojected image; and obtaining a bandwidth parameter per pixel of the filter by upsampling an output of the artificial neural network.

The determining the relationship may include setting a plurality of windows for the first image, the second image, and the at least one G-buffer image and determining the relationship between the first image and the second image for each of the plurality of windows.

The generating the target image may include generating the target image by combining a first output image, obtained by applying a first filter to the first intermediate image, with a second output image, obtained by applying a second filter to the second intermediate image. The first filter may be determined by applying a bandwidth parameter related to the first intermediate image among the bandwidth parameters to the filter. The second filter may be determined by applying a bandwidth parameter related to the second intermediate image among the bandwidth parameters to the filter.

The operation method may further include determining a loss function of the artificial neural network; and updating the artificial neural network based on the loss function.

The updated artificial neural network may be used to determine bandwidth parameters of the filter for removing a noise from a next frame of the current frame.

According to an aspect of an example embodiment of the disclosure, there is provided an operation method of an electronic device, the operation method including: generating, based on a view point of a current frame, a first image, a second image, and a geometry (G)-buffer image; determining, based on the first image, the second image, and the at least one G-buffer image, a relationship between the first image and the second image, wherein the relationship is expressed linearly; generating, based on the relationship, a first intermediate image and a second intermediate image, from which a portion of a noise in the first image and the second image is removed, respectively; downsampling the first intermediate image, the second intermediate image, the at least one G-buffer image, and a reprojected image obtained when an output image of a previous frame of the current frame is reprojected from the view point of the current frame; inputting, to an artificial neural network, the downsampled first intermediate image, the downsampled second intermediate image, the downsampled at least one G-buffer image, and the downsampled reprojected image; determining bandwidth parameters of a filter for removing a noise from the first intermediate image and the second intermediate image by upsampling an output of the artificial neural network; and generating a target image, which is an output image of the current frame, by removing the noise from the first intermediate image and the second intermediate image using the filter to which the bandwidth parameters are applied.

The first image and the at least one G-buffer image may be images generated from the view point of the current frame, and the second image may be an image generated from the view point of the current frame or a view point of the previous frame.

According to an aspect of an example embodiment of the disclosure, there is provided an electronic device including: memory including instructions; and at least one processor configured to execute the instructions, wherein the instructions, when executed individually and/or collectively by the at least one processor, cause the electronic device to: generate, based on a view point of a current frame, a first image, a second image, and at least one geometry (G)-buffer image; determine, based on the first image, the second image, and the at least one G-buffer image, a relationship between the first image and the second image; generate, based on the relationship, a first intermediate image and a second intermediate image, from which a portion of a noise in the first image and the second image is removed, respectively; determine bandwidth parameters of a filter for removing a noise from the first intermediate image and the second intermediate image by inputting, to an artificial neural network, the first intermediate image, the second intermediate image, the at least one G-buffer image, and a reprojected image obtained when an output image of a previous frame of the current frame is reprojected from the view point of the current frame; and generate a target image, which is an output image of the current frame, by removing the noise from the first intermediate image and the second intermediate image using the filter to which the bandwidth parameters are applied.

The instructions, when executed individually and/or collectively by the at least one processor, may cause the electronic device to determine a first relationship between a pixel value of the first image and pixel variables of the second image and determine a second relationship between a pixel value of the second image and pixel variables of the first image.

The first relationship and the second relationship may be expressed linearly.

The first image and the at least one G-buffer image may be images generated from the view point of the current frame, and the second image may be an image generated from a view point of the current frame or a view point of the previous frame.

The instructions, when executed individually and/or collectively by the at least one processor, may cause the electronic device to: downsample the first intermediate image, the second intermediate image, the at least one G-buffer image, and the reprojected image and input, to the artificial neural network, the donwsampled first intermediate image, the downsampled second intermediate image, the downsampled at least one G-buffer image, and the downsampled reprojected image; and obtain a bandwidth parameter per pixel of the filter by upsampling an output of the artificial neural network.

The instructions, when executed individually and/or collectively by the at least one processor, may cause the electronic device to set a plurality of windows for the first image, the second image, and the at least one G-buffer image and determine the relationship between the first image and the second image for each of the plurality of windows.

The instructions, when executed individually and/or collectively by the at least one processor, may cause the electronic device to generate the target image by combining a first output image, obtained by applying a first filter to the first intermediate image, with a second output image, obtained by applying a second filter to the second intermediate image. The first filter may be determined by applying a bandwidth parameter related to the first intermediate image among the bandwidth parameters to the filter. The second filter may be determined by applying a bandwidth parameter related to the second intermediate image among the bandwidth parameters to the filter.

The instructions, when executed individually and/or collectively by the at least one processor, may cause the electronic device to: determine a loss function of the artificial neural network; and update the artificial neural network based on the loss function.

The updated artificial neural network may be used to determine bandwidth parameters of the filter for removing a noise from a next frame of the current frame.

According to an aspect of an example embodiment of the disclosure, there is provided a non-transitory computer-readable storage medium storing one or more computer programs including instructions to execute: generating, based on a view point of a current frame, a first image, a second image, and at least one geometry (G)-buffer image; determining, based on the first image, the second image, and the at least one G-buffer image, a relationship between the first image and the second image; generating, based on the relationship, a first intermediate image and a second intermediate image, from which a portion of a noise in the first image and the second image is removed, respectively; determining bandwidth parameters of a filter for removing a noise from the first intermediate image and the second intermediate image by inputting, to an artificial neural network, the first intermediate image, the second intermediate image, the at least one G-buffer image, and a reprojected image obtained when an output image of a previous frame of the current frame is reprojected from the view point of the current frame; and generating a target image, which is an output image of the current frame, by removing the noise from the first intermediate image and the second intermediate image using the filter to which the bandwidth parameters are applied.

### BRIEF DESCRIPTION OF THE DRAWINGS

The above and/or other aspects will be more apparent from descriptions of certain example embodiments referring to the accompanying drawings, in which:

FIG. 1 is a diagram illustrating an electronic device according to an embodiment;

FIG. 2 is a block diagram illustrating operations of an electronic device according to an embodiment;

FIG. 3 is a diagram illustrating a window according to an embodiment;

FIGS. 4 to 6 are flowcharts illustrating operations of an electronic device according to embodiments;

FIG. 7 is a diagram illustrating a connection relationship between frames according to an embodiment; and

FIG. 8 is a flowchart illustrating operations of an electronic device according to an embodiment.

### DETAILED DESCRIPTION

The following structural or functional descriptions of example embodiments are provided as examples only, and various alterations and modifications may be made to the example embodiments. Accordingly, the embodiments are not construed as limited to the disclosure and should be understood to include all changes, equivalents, and replacements within the idea and the technical scope of the disclosure.

Terms, such as first, second, and the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, components, or groups thereof but do not preclude the presence or addition of one or more other features, integers, steps, operations, elements, components, or groups thereof.

Unless otherwise defined, all terms used herein including technical or scientific terms have the same meaning as commonly understood by one of ordinary skill in the art to which this disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, example embodiments will be described in detail with reference to the accompanying drawings. When describing the embodiments with reference to the accompanying drawings, like reference numerals refer to like elements and any repeated description related thereto will be omitted.

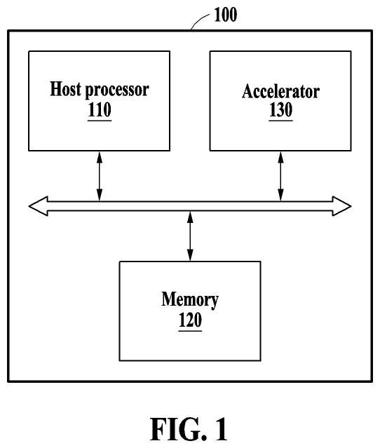

FIG. 1 is a diagram illustrating an electronic device according to an embodiment.

Referring to FIG. 1, an electronic device 100 may include a host processor 110, memory 120, and an accelerator 130. The host processor 110, the memory 120, and the accelerator 130 may communicate with one another through a bus, network on a chip (NoC), peripheral component interconnect express (PCIe), or the like. In the electronic device 100 illustrated in FIG. 1, only components related to the present embodiment are shown. Accordingly, it is apparent to those skilled in the art that the electronic device 100 may further include other general-purpose components in addition to the components shown in FIG. 1.

The host processor 110 may serve to perform overall functions for controlling the electronic device 100. By executing programs and/or instructions stored in the memory 120, the host processor 110 may generally control the electronic device 100. The host processor 110 may be implemented as a central processing unit (CPU), a graphics processing unit (GPU), an application processor (AP), or the like provided within the electronic device 100, but embodiments are not limited thereto.

The memory 120 may be hardware that stores data processed by the electronic device 100 and/or data to be processed by the electronic device 100. Additionally, the memory 120 may store applications, drivers, and the like to be operated by the electronic device 100. The memory 120 may include volatile memory, such as dynamic random access memory (DRAM), and/or nonvolatile memory.

The electronic device 100 may include the accelerator 130 for operations. The accelerator 130 may handle tasks that, due to the nature of the operations, are more efficiently processed by a dedicated processor, that is, the accelerator 130, rather than by the general-purpose host processor 110. In this case, one or more processing elements (PEs) included in the accelerator 130 may be utilized. The accelerator 130 may correspond to, for example, a neural processing unit (NPU), a tensor processing unit (TPU), a digital signal processor (DSP), a GPU, a neural engine, or the like, which perform operations based on a neural network.

The operations of the electronic device 100 described below may be implemented by at least one processor. For example, the operations of the electronic device may be implemented by the accelerator 130. However, the embodiments are not limited thereto, and the operations of the electronic device 100 may also be implemented by the host processor 110. When executed individually and/or collectively by at least one processor, the instructions stored in the memory 120 may cause the electronic device to perform the operations described herein.

The electronic device 100 may render an image. The electronic device 100 may render an image sequence. For example, the electronic device 100 may sequentially render a plurality of frame images. The electronic device 100 may render an image using ray tracing.

Ray tracing-based image rendering may require the use of statistical methods, such as Monte Carlo integration, to simulate a path of light. However, when a number of samples applied to each pixel of an image is small, noise may occur due to statistical limitations. Increasing the number of samples may reduce noise, but a rendering time may be extended accordingly, thereby limiting performance.

Even with fastest path tracing technique on modern graphics hardware, only a small number (e.g., 1 to 4) of samples per pixel may be processed in real time. Since images rendered with such a small number of samples tend to have significant noise, a technique for removing noise in real time may need to be applied to achieve a high-quality image in real time.

Hereinafter, the electronic device 100 that removes noise in real time according to an embodiment is described.

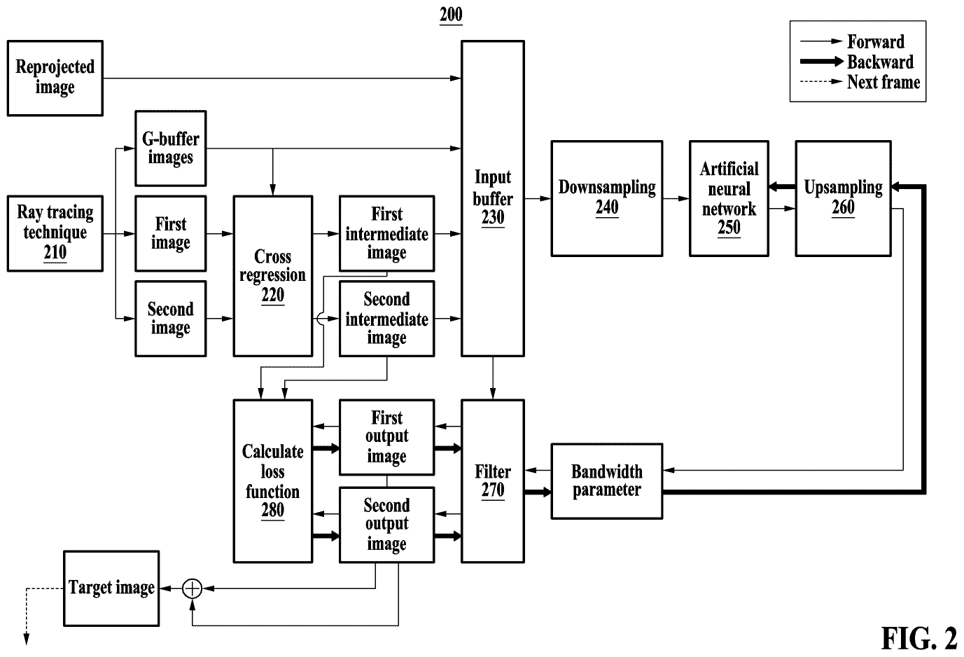

FIG. 2 is a block diagram illustrating operations of an electronic device according to an embodiment

Referring to FIG. 2, a block diagram 200 is shown to describe a method of removing noise from a current frame in real time.

In block 210, an electronic device may generate, using a ray tracing technique, a first image, a second image, and geometry (G)-buffer images based on a view point of a current frame. The electronic device may generate, based on the view point of the current frame, a first image and G-buffer images for a three-dimensional (3D) scene of the current frame. According to an embodiment, the electronic device may generate a second image for the 3D scene of the current frame based on the view point of the current frame or generate the second image for the 3D scene based on a view point of a previous frame (e.g., an immediately preceding frame). For example, the electronic device may perform the ray tracing technique twice from the view point of the current frame to generate the first image and the second image. For example, the electronic device may use the image generated via the ray tracing technique in the immediately preceding frame as the second image. The first image and the second image may include color images. For ease of description, the first image may be indexed as A, and the second image may be indexed as B.

The first image and the second image may include noise. The first image and the second image may be generated by independent methods, and the first image and the second image may include noise at different pixel locations. The first image and the second image may include different noise patterns.

The G-buffer images may include various attributes of a scene for each pixel. For example, the G-buffer images may include images including various attributes, such as an image representing a normal vector of each pixel, an image representing a depth of each pixel, an image representing a color of each pixel, and an image representing a texture of each pixel.

In block 220, the electronic device may perform cross regression using the first image, the second image, and the G-buffer images.

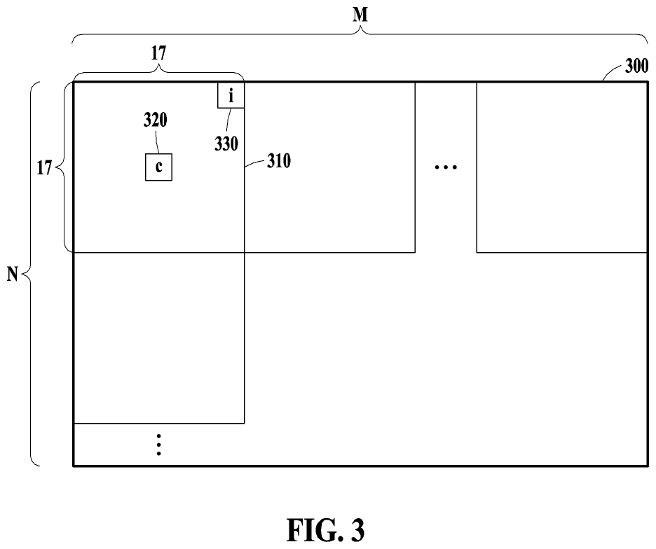

The electronic device may determine a relationship between the first image and the second image based on the first image, the second image, and the G-buffer images. The relationship between the first image and the second image may be expressed linearly. For example, the electronic device may perform linear regression by crossing independent and dependent variables of the first image with independent and dependent variables of the second image. Cross regression will be described later with reference to FIG. 3.

The electronic device may perform cross regression to generate a first intermediate image and a second intermediate image. The first intermediate image may be an image obtained by removing a portion of noise from the first image. The second intermediate image may be an image obtained by removing a portion of noise from the second image.

In block 230, the electronic device may receive, from an input buffer, the first intermediate image, the second intermediate image, the G-buffer images, and a reprojected image. The reprojected image may be an output image output from the previous (e.g., immediately preceding) frame of the current frame reprojected from the view point of the current frame. The first intermediate image, the second intermediate image, the G-buffer images, and the reprojected image received from the input buffer may be transmitted to an artificial neural network and a filter.

In block 240, the electronic device may perform downsampling on the received first intermediate image, second intermediate image, G-buffer images, and reprojected image.

In block 250, the electronic device may input, to an artificial neural network, the downsampled first intermediate image, the downsampled second intermediate image, the downsampled G-buffer images, and the downsampled reprojected image. The artificial neural network may be a neural network trained to determine a bandwidth parameter of a filter for removing noise.

In block 260, the electronic device may upsample an output of the artificial neural network. By upsampling the output of the artificial neural network, the electronic device may obtain the bandwidth parameter of the filter for removing noise.

According to an embodiment, downsampling and upsampling may be implemented as layers of the artificial neural network. According to an embodiment, a layer performing upsampling may be a sub-pixel convolution layer.

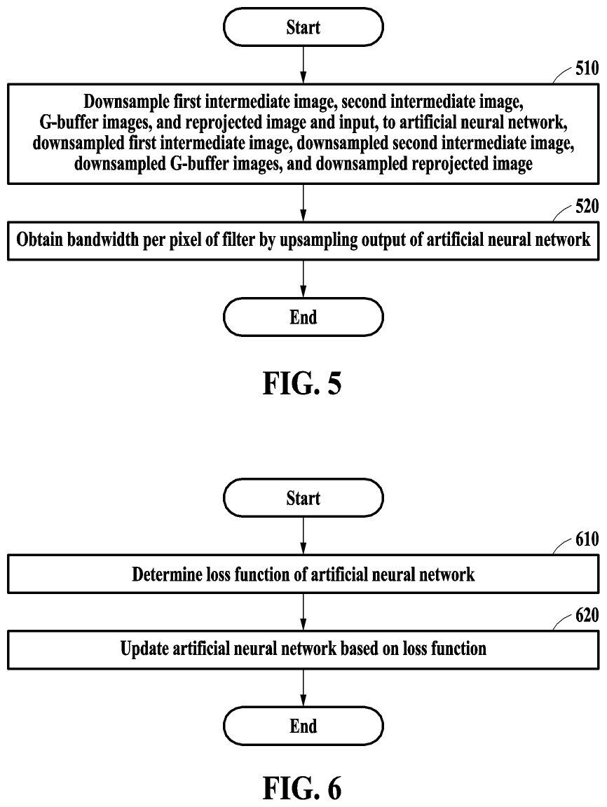

A method by which an artificial neural network outputs the bandwidth parameter will be described later with reference to FIG. 5.

In block 270, the electronic device may remove noise from the first intermediate image and the second intermediate image using a filter to which the bandwidth parameter obtained through the artificial neural network is applied. The electronic device may output a first output image and a second output image from which noise is removed through the filter. A method by which the electronic device removes noise will be described later with reference to FIG. 5.

The electronic device may combine the first output image with the second output image. By combining the first output image with the second output image, the electronic device may generate a target image, which is an output image of the current frame. The target image may be displayed on a display as the output image of the current frame. The target image may be used to remove noise in a next frame. For example, similar to the reprojected image input in block 230, the target image may be reprojected from the view point of the next frame and used to remove noise in the next frame.

In block 280, the electronic device may calculate a loss function to update the artificial neural network. After calculating the loss function, the electronic device may perform backpropagation to update the artificial neural network that outputs the bandwidth parameter of the filter. The updated artificial neural network may be used to determine the bandwidth parameter of the filter to be applied for the next frame. The process of updating the artificial neural network will be described later with reference to FIG. 6.

The operations of the electronic device described above may be performed on a window-by-window basis for an image. For example, a plurality of windows may be set for the first image, the second image, and the G-buffer images, and the aforementioned operations may be performed for each window. Hereinafter, a window according to an embodiment is described.

FIG. 3 is a diagram illustrating a window according to an embodiment.

FIG. illustrates an image 300. The size of the image 300 may be M×N. A plurality of windows may be set for the image 300. For example, a plurality of windows 310 having 16 center pixels among pixels included in the image 300 may be set.

A size of the window 310 may be K×K. K may be an odd natural number. For example, the size of the window 310 may be 17×17. A pixel located at a center of the window 310 may be referred to as a center pixel 320. The center pixel 320 may be indexed as c. i may represent a pixel other than the center pixel 320 among the pixels included in the window 310 and may be referred to as a neighboring pixel 330. The neighboring pixel 330 may be indexed as i, i being a natural number.

Herein, Ω_{c} may refer to the window 310 centered around the center pixel c. The plurality of windows 310 may be set at same corresponding locations for the first image, the second image, and the G-buffer images.

Hereinafter, operations of the electronic device for removing noise in real time is described in detail.

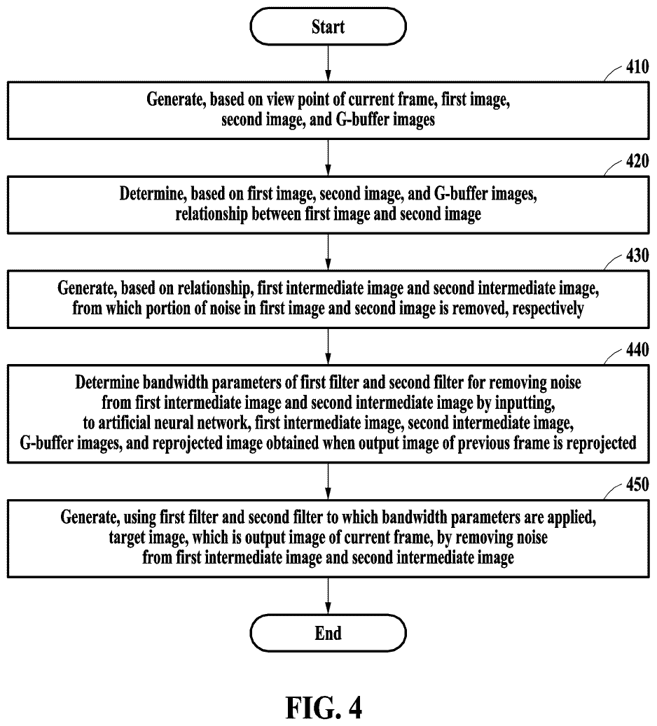

FIGS. 4 to 6 are flowcharts illustrating operations of an electronic device according to embodiments.

FIG. 4 illustrates a flowchart illustrating operations of an electronic device for removing noise. In the following embodiments, the operations may be performed sequentially but not necessarily. For example, the order of the operations may be changed, and at least two operations may be performed in parallel. According to an embodiment, at least two operations may be merged, an operation may be divided, a specific operation may not be performed, and/or another operation may be additionally included. According to an embodiment, when instructions stored in memory are executed individually and/or collectively by at least one processor, operations 410 to 450 may be performed by the electronic device.

In operation 410, the electronic device may generate, based on a view point of a current frame, a first image, a second image, and G-buffer images.

The electronic device may generate the first image, the second image, and the G-buffer images using a ray tracing technique. The first image, the second image, and the G-buffer images are described above with reference to FIG. 2, and thus, a detailed description thereof is omitted.

In operation 420, the electronic device may determine, based on the first image, the second image, and the G-buffer images, the relationship between the first image and the second image.

The relationship may be expressed linearly. For example, the relationship may be expressed based on a linear regression equation. The basic equation for linear regression may be expressed by Equation 1.

In the following Equations, descriptions of parameters may be equally applied, and thus, further descriptions will be omitted to avoid redundancy.

$${y}_{i} = f ( {x}_{i} ) + {e}_{i} \qquad [ Equation 1 ]$$

Equation 1 represents a basic equation of linear regression, which estimates a function ƒ(x) using observed data (xᵢ, yᵢ). Here, eᵢ may be additive noise with an expected value of 0 (e.g., E(eᵢ)=0). An independent variable xᵢ may be a feature of a pixel i (or a neighboring pixel) and may include noise. yᵢ may be a pixel value of the pixel i, which may include noise.

For example, ƒ(xᵢ) may be a ground truth of a pixel value of the pixel i, rendered based on infinite samples. yᵢ may be a pixel value of the pixel i rendered based on finite samples and may include noise.

Based on Equation 1 described above, the ground truth of the pixel i in a window (e.g., Ω_{c}) centered around the pixel c may be linearly approximated as shown in Equation 2.

$$f ( {x}_{i} ) = {α}_{c} + {β}_{c}^{T} ( {x}_{i} - {x}_{c} ) \qquad [ Equation 2 ]$$

ƒ(xᵢ) is a ground truth of the neighboring pixel i within the window (e.g., Ω_{c}) and may represent a dependent variable. xᵢ is an independent variable and may represent a pixel variable of the pixel i. x_{c} is an independent variable and may represent a pixel variable of the pixel c. A pixel variable may be a feature of a pixel. According to an embodiment, the pixel variable may be determined based on the G-buffer images. α_{c} may be an estimated value of a ground truth (e.g., ƒ(x_{c})) of a pixel value of the pixel c. β_{c} may be an estimated value of a change in color (e.g., gradient) around the pixel c. Equation 2 may predict a linear change from ac ƒ(x) and

In Equation 2 described above, α_{c} and β_{c} may be determined through a least square objective function at the pixel c. The least square objective function may be expressed by Equation 3 below.

$$[ \begin{matrix}{α}_{c} \\ {β}_{c}\end{matrix} ] = {arg min}_{{\tilde{α}}_{c} , {\tilde{β}}_{c}} {\sum }_{i ∈ {Ω}_{c}} {{w}_{c , i} ( {y}_{i} - {\tilde{α}}_{c} - {\tilde{β}}_{c}^{T} ( {x}_{i} - {x}_{c} ) )}^{2} \qquad [ Equation 3 ]$$

w_{c,i} may be a weight that controls a relative importance of a squared error at the pixel i. w_{c,i} may be determined based on a similarity between the pixel c and the pixel i. w_{c,i} may need to be set high only when xᵢ−x_{c} may linearly predict ƒ(xᵢ)−ƒ(x_{c}). \tilde{α}_{c} and \tilde{β}_{c} are variables used in an optimization equation and may be optimization variables. 00 and may be intermediate estimates of alpha and beta, respectively.

α_{c} and β_{c} may be determined through Equation 4 below. Equation 4 may be a normal equation.

$$[ \begin{matrix}{α}_{c} \\ {β}_{c}\end{matrix} ] = {( {X}_{c}^{T} {W}_{c} {X}_{c} )}^{- 1} {X}_{c}^{T} {W}_{c} {Y}_{c} \qquad [ Equation 4 ]$$

Matrices included in Equation 4 may be defined as shown in Equation 5 below.

$${X}_{c} = {[ \begin{matrix}⋮ \\ 1 , {( {x}_{i} - {x}_{c} )}^{T} \\ ⋮\end{matrix} ]}_{,} {Y}_{c} = {[ \begin{matrix}⋮ \\ {y}_{i} \\ ⋮\end{matrix} ]}_{,} {W}_{c} = [ \begin{matrix}⋱ & & \\ & {w}_{c , i} & \\ & & ⋱\end{matrix} ] \qquad [ Equation 5 ]$$

The electronic device may determine α_{c} and β_{c} based on Equation 3, Equation 4, and Equation 5.

The electronic device may generate an intermediate image (e.g., \tilde{ƒ}(x), obtained by removing a portion of noise from an image based on the determined ac and Be. The intermediate image may be determined as shown in Equation 6.

$$\tilde{f} ( {x}_{i} ) = \frac{{\sum }_{c ∈ {Ω}_{i}} {w}_{c , i} ( {α}_{c} + {β}_{c}^{T} ( {x}_{i} - {x}_{c} ) )}{{\sum }_{c ∈ {Ω}_{i}} {w}_{c , i}} \qquad [ Equation 6 ]$$

An operation of generating the intermediate image described above may be performed for each of the plurality of windows. The operation of generating the intermediate image described above may utilize a single image generated from the current frame.

Hereinafter, a method of generating intermediate images through cross regression using two images (e.g., the first image and the second image) is described. For ease of description, the description is based on the first image (e.g., index A). However, it is evident to those skilled in the art that the following description may be equally applied to the second image (e.g., index B).

The electronic device may express

$${x}_{i}^{A} - {x}_{c}^{A}$$

in the window (e.g., Ω_{c}) centered on the pixel c of the first image as shown in Equation 7 below.

$${x}_{i}^{A} - {x}_{c}^{A} = {[ \frac{{𝓎}_{i}^{A} - {𝓎}_{c}^{A}}{{\hat{σ}}_{i}^{A} + {\hat{σ}}_{c}^{A} + ϵ} , {ℊ}_{i} - {ℊ}_{c} ]}^{T} \qquad [ Equation 7 ]$$

$${x}_{i}^{A}$$

may represent a pixel variable of the pixel i in the first image, and

$${x}_{c}^{A}$$

may represent a pixel variable of the pixel c in the first image.

$${y}_{i}^{A}$$

may represent a pixel value of the pixel i in the first image.

$${y}_{c}^{A}$$

may represent a pixel value of the pixel c in the first image. Both

$${y}_{i}^{A} and {y}_{c}^{A}$$

may include noise according to Equation 1.

$${\hat{σ}}_{i}^{A}$$

may be an estimated standard deviation of

$${y}_{i}^{A}$$

in the first image, and

$${\hat{σ}}_{c}^{A}$$

may be an estimated standard deviation of

$${y}_{c}^{A}$$

in the first image. ∈ may be a constant to prevent division by zero.

$${\hat{σ}}_{i}^{A}$$

may be determined based on a variance calculated from a square of a difference between the pixel value of the pixel i and a mean of pixel values of surrounding 8 pixels excluding the pixel i in a predetermined 3×3 window.

$${\hat{σ}}_{c}^{A}$$

may be determined based on a variance calculated from a square of a difference between the pixel value of the pixel c and a mean of pixel values of surrounding 8 pixels excluding the pixel c in a predetermined 3×3 window. gᵢ−g_{c} may be a difference between the pixel variable of the pixel i and the pixel variable of the pixel c in a G-buffer image.

According to an embodiment, gᵢ−g_{c} may include, which represents a difference between the pixel variable of the pixel i and the pixel variable of the pixel c in a G-buffer image that represents a texture. According to an embodiment, gᵢ−g_{c} may include nᵢ−n_{c}, which represents a difference between the pixel variable of the pixel i and the pixel variable of the pixel c in a G-buffer image that represents a normal vector.

A weight

$$( e . g . , {w}_{c , i}^{A} )$$

that controls a relative importance of a squared error at the pixel i in the first image may be expressed by Equation 8 below.

$${w}_{c , i}^{A}$$

may be determined based on a similarity between the pixel c and the pixel i in the first image.

$${w}_{c , i}^{A} = exp ( - \frac{{‖ {y}_{i}^{A} - {y}_{c}^{A} ‖}^{2}}{{( {\hat{σ}}_{c}^{A} )}^{2} + {( {\hat{σ}}_{i}^{A} )}^{2} + ϵ} ) \qquad [ Equation 8 ]$$

Although omitted from this disclosure, it is apparent to those skilled in the art that

$${x}_{i}^{B} - {x}_{c}^{B} and {w}_{c , i}^{B}$$

in the second image may be determined in the same manner as described above.

The electronic device may determine

$${α}_{c}^{A} and {β}_{c}^{A}$$

based on a normal equation and the least square objective function to which

$${x}_{i}^{A} - {x}_{c}^{A} and {w}_{c , i}^{A}$$

are applied. The normal equation may be expressed by Equation 9. Since Equation 3, which is the least square objective function, may be applied to Equation 9 in the same way as Equation 4, which is the normal equation, is applied to Equation 9, a detailed description thereof is omitted.

$$[ \begin{matrix}{α}_{c}^{A} \\ {β}_{c}^{A}\end{matrix} ] = {( {( {X}_{c}^{A} )}^{T} {W}_{c}^{A} {X}_{c}^{A} )}^{- 1} {( {X}_{c}^{A} )}^{T} {W}_{c}^{A} {Y}_{c}^{A} \qquad [ Equation 9 ]$$

$${X}_{c}^{A} , {Y}_{c}^{A} , and {W}_{c}^{A}$$

in Equation 9 may be expressed by Equation 10.

$${X}_{c}^{A} = [ \begin{matrix}⋮ \\ 1 , {( {x}_{i}^{A} - {x}_{c}^{A} )}^{T} \\ ⋮\end{matrix} ] , {Y}_{c}^{A} = [ \begin{matrix}⋮ \\ {y}_{i}^{B} \\ ⋮\end{matrix} ] , {W}_{c}^{A} = [ \begin{matrix}⋱ & & \\ & {w}_{c , i}^{A} & \\ & & ⋱\end{matrix} ] \qquad [ Equation 10 ]$$

Referring to

$${Y}_{c}^{A} ,$$

a pixel value in a corresponding window of the second image may be included rather than a pixel value in a window of the first image.

Pixel variables of the first image and the pixel values of the second image may be crossed. By using the pixel value in the corresponding window of the second image in

$${Y}_{c}^{A} ,$$

a linear relationship between the pixel variables of the first image and the pixel value of the second image may be estimated. Similarly, a linear relationship between a pixel value of the first image and pixel variables of the second image may also be estimated.

By cross-using independent variables of the first image and dependent variables of the second image, a relationship between the independent variables of the first image and dependent variables of the second image may be estimated. By cross-using independent variables of the second image and dependent variables of the first image, a relationship between the independent variables of the second image and the dependent variables of the first image may be estimated.

The electronic device may determine

$${α}_{c}^{A} and {β}_{c}^{A}$$

based on the normal equation and the least square objective function.

$${α}_{c}^{A} and {β}_{c}^{A}$$

may include the relationship between the first image and the second image. The electronic device may determine a linear regression equation that includes the relationship between the first image and the second image based on Equation 1.

In operation 430, the electronic device may generate, based on the relationship, a first intermediate image and a second intermediate image, from which a portion of noise in the first image and the second image is removed, respectively.

The electronic device may generate a first intermediate image (e.g., \tilde{ƒ}(x^{A})) obtained by removing a portion of noise from the first image based on

$${α}_{c}^{A} and {β}_{c}^{A} .$$

The electronic device may generate \tilde{ƒ}(x^{A}) as in Equation 11 below.

$$\tilde{f} ( {x}^{A} ) = \frac{{\sum }_{c ∈ {Ω}_{i}} {w}_{c , i}^{A} ( {α}_{c}^{A} + {( {β}_{c}^{A} )}^{T} ( {x}_{i}^{A} + {x}_{c}^{A} ) )}{{\sum }_{c ∈ {Ω}_{i}} {w}_{c , i}^{A}}$$

The electronic device may generate a second intermediate image (e.g., \tilde{ƒ}(x^{B}) obtained by removing a portion of noise using the same method as described above.

As described above, when a linear regression equation is determined from the independently generated first and second images, which include noise, using a pixel value from another image, the first intermediate image and the second intermediate image may include residual noise but may have less bias compared to a related art noise removal method. Therefore, the first intermediate image and the second intermediate image may be used as labels for training an artificial neural network.

In operation 440, the electronic device may input, to the artificial neural network, the first intermediate image, the second intermediate image, the G-buffer images, and a reprojected image obtained when an output image of the previous (e.g., immediately preceding) frame of the current frame is reprojected from the view point of the current frame and may determine a bandwidth parameter of a filter for removing noise from the first intermediate image and the second intermediate image. The bandwidth parameter may include bandwidth parameters, and the bandwidth parameters may include a bandwidth parameter related to a first filter to be used to remove noise from the first intermediate image and a bandwidth parameter related to a second filter to be used to remove noise from the second intermediate image.

A method of determining a bandwidth parameter of a filter will be described later with reference to FIG. 5.

In operation 450, the electronic device may remove noise from the first intermediate image and the second intermediate image using a filter to which the bandwidth parameter is applied and generate a target image, which is an output image of the current frame.

The electronic device may generate a first output image obtained by removing noise from the first intermediate image using the first filter and a second output image obtained by removing noise from the second intermediate image using the second filter. In an embodiment, the first output image may be obtained when the first intermediate image passes through the first filter, and the second output image may be obtained when the second intermediate image passes through the second filter. The first filter may be determined by applying a bandwidth parameter related to the first intermediate image to the filter among bandwidth parameters. The second filter may be determined by applying a bandwidth parameter related to the second intermediate image to the filter among the bandwidth parameters.

The electronic device may output the target image, which is the output image of the current frame, by combining the first output image with the second output image.

The electronic device may determine a loss function of the artificial neural network that determines the bandwidth parameters of the filter. Based on the loss function, the electronic device may update the artificial neural network. The update of the artificial neural network will be described later with reference to FIG. 6.

Operations 410 to 450 described above may be performed for each of the plurality of windows.

FIG. 5 illustrates a flowchart illustrating a method of obtaining a bandwidth parameter according to an embodiment.

In the following embodiments, each operation may be performed sequentially but not necessarily. For example, the order of the operations may be changed, and at least two of the operations may be performed in parallel. According to an embodiment, at least two operations may be merged, an operation may be divided, a specific operation may not be performed, and/or another operation may be additionally included. According to an embodiment, when instructions stored in memory are executed individually and/or collectively by at least one processor, operations 510 and 520 may be performed by an electronic device.

In operation 510, the electronic device may downsample a first intermediate image, a second intermediate image, G-buffer images, and a reprojected image and input, to an artificial neural network, the downsampled first intermediate image, the downsampled second intermediate image, the downsampled G-buffer images, and the downsampled reprojected image.

The first intermediate image, the second intermediate image, the G-buffer images, and the reprojected image may be referred to as input images. To perform inference and training of the artificial neural network in real time, a resolution of the input images may need to be reduced. The electronic device may downsample the input images to lower resolutions of the input images.

In operation 520, the electronic device may obtain a bandwidth parameter per pixel of a filter by upsampling an output of the artificial neural network.

The artificial neural network may infer the bandwidth parameter per pixel of the filter from the downsampled input images. A first filter, which is a filter for removing noise from the first intermediate image, may be determined by applying a bandwidth parameter related to the first intermediate image to the filter among the bandwidth parameters. A second filter, which is a filter for removing noise from the second intermediate image, may be determined by applying a bandwidth parameter related to the second intermediate image to the filter among the bandwidth parameters.

Since the bandwidth parameters output from the artificial neural network are obtained from the downsampled images, resolutions of the bandwidth parameters may be low. The electronic device may obtain bandwidth parameters

$$( e . g . , {θ}_{c} = [ {θ}_{c}^{A} , {θ}_{c}^{B} , {θ}_{c}^{ρ} , {θ}_{c}^{n} , {θ}_{c}^{p} , {θ}_{c}^{α} , ] )$$

with six parameters per pixel by upsampling the output of the artificial neural network.

$${θ}_{c}^{A} and {θ}_{c}^{B}$$

may be bandwidth parameters for a difference between the first image and the second image.

$${θ}_{c}^{ρ}$$

may be a bandwidth parameter for a texture image, which is a G-buffer image.

$${θ}_{c}^{n}$$

may be a bandwidth parameter of a normal image, which is a G-buffer image.

$${θ}_{c}^{p}$$

may be a bandwidth parameter for an Euclidean distance between pixels.

$${θ}_{c}^{α}$$

may be a bandwidth parameter that determines a ratio of mixing the reprojected image, which is reprojected from a previous frame, and an image of the current frame in the filter. The closer

$${θ}_{c}^{α}$$

is to 1, the more the image of the current frame is mixed, and the closer

$${θ}_{c}^{α}$$

is to 0, the more the reprojected image, which is reprojected from the previous frame, is mixed.

As

$${θ}_{c}^{A} , {θ}_{c}^{B} , {θ}_{c}^{ρ} , {θ}_{c}^{n} , and {θ}_{c}^{p}$$

increase, the filter becomes less sensitive to the difference between a pixel i and a pixel c. For example, when the difference between the pixel i and the pixel c is very large, the bandwidth parameters may be adjusted to be less influenced by a weight of the filter.

According to an embodiment, the electronic device may upsample the output of the artificial neural network using a sub-pixel convolution layer. The sub-pixel convolution layer may perform the following operation.

$${PS ( T )}_{x , y , c} = {T}_{⌊ x / r ⌋ , ⌊ y , r ⌋ , C \cdot r \cdot mod ( y , r ) + C \cdot mod ( x , r ) + c} \qquad [ Equation 12 ]$$

T may be an output of a previous layer (e.g., the output of the artificial neural network) and may have a lower resolution but a larger number of channels. C may be a number of channels (e.g., a number of bandwidth parameters). r may be a resolution ratio. x and y may be pixel indices. C may be a channel index. For example, when r is 2, the output of the previous layer with a resolution of 960×540×24 may be used to determine a bandwidth parameter with a resolution of 1920×1080×6.

According to an embodiment, downsampling and upsampling may be performed in a predetermined layer. A downsampling layer, the artificial neural network, and an upsampling layer may form an artificial neural network with a U-NET structure.

According to an embodiment,

$${θ}_{c}^{A} , {θ}_{c}^{ρ} , {θ}_{c}^{n} , {θ}_{c}^{p} , and {θ}_{c}^{α}$$

may be bandwidth parameters related to the first intermediate image.

$${θ}_{c}^{B} , {θ}_{c}^{p} , {θ}_{c}^{n} , {θ}_{c}^{p} , and {θ}_{c}^{α}$$

may be bandwidth parameters related to the second intermediate image. Herein, for ease of description, a description is provided based on the first filter to which the bandwidth parameters related to the first intermediate image are applied. However, it is apparent to those skilled in the art that the following description may also be applied to the second filter to which the bandwidth parameters related to the second intermediate image are applied.

The electronic device may generate an output image based on the input images by applying bandwidth parameters to the filter. The filter may include a spatiotemporal filter. Before generating the output image (e.g., a first output image), the electronic device may determine a weight

$$( e . g . , {m}_{i}^{A} ) .$$

The electronic device may perform a weighted average using neighboring pixels to determine the pixel value of the pixel c in the first output image, and the weight may be a weight for the neighboring pixel i.

The electronic device may determine

$${m}_{i}^{A}$$

based on Equation 13 below.

$$[ Equation 13 ]$$

$${m}_{i}^{A} = exp ( - \frac{{‖ \tilde{f} ( {x}_{i}^{A} ) - \tilde{f} ( {x}_{c}^{A} ) ‖}^{2}}{{( {θ}_{c}^{A} )}^{2} + ϵ} ) \times exp ( - \frac{{‖ {ρ}_{i} - {ρ}_{c} ‖}^{2}}{{( {θ}_{c}^{ρ} )}^{2} + ϵ} - \frac{{‖ {n}_{i} - {n}_{c} ‖}^{2}}{{( {θ}_{c}^{n} )}^{2} + ϵ} - \frac{{‖ {p}_{i} - {p}_{c} ‖}^{2}}{{( {θ}_{c}^{p} )}^{2} + ϵ} )$$

pᵢ and p_{c} may represent pixel positions of the pixel i and the pixel c, respectively.

$$\tilde{f} ( {x}_{i}^{A} )$$

may represent a pixel value of the pixel i in the first intermediate image.

$$\tilde{f} ( {x}_{c}^{A} )$$

may represent a pixel value of the pixel c in the first intermediate image.

The electronic device may generate a first output image

$$( \hat{f} ( {x}_{c}^{A} ) )$$

obtained by removing noise from the first intermediate image based on

$${m}_{i}^{A}$$

and the input images. The electronic device may generate the first output image based on Equation 14.

$$\hat{f} ( {x}_{c}^{A} ) = {θ}_{c}^{α} \frac{{\sum }_{i ∈ {Ω}_{c}^{′}} {m}_{i}^{A} \tilde{f} ( {x}_{i}^{A} )}{{\sum }_{i ∈ {Ω}_{c}^{′}} {m}_{i}^{A}} + ( 1 - {θ}_{c}^{α} ) ℛ {\hat{f}}^{p} ( {x}_{c} ) \qquad [ Equation 14 ]$$

R\hat{ƒ}^{p}(x_{c}) may represent the reprojected image. R\hat{ƒ}^{p}(x_{c}) may represent the reprojected image obtained when the output image (or target image) of the previous (e.g., immediately preceding) frame is reprojected from the view point of the current frame.

$${Ω}_{c}^{′}$$

may represent a window used in the filter. For example,

$${Ω}_{c}^{′}$$

may have a size of 11×11. The size of the window used in the filter may be less than the size of a window used in cross regression. Since the filter uses an intermediate image with less noise, the filter may utilize a smaller window compared to cross regression, which uses a very noisy image. As the size of a window increases, computational load grows, causing slower processing and blurrier results.

The electronic device may generate the first output image based on Equation 14, which determines the pixel value of the pixel c in the first output image. The electronic device may be determined based on a weighted sum of the pixel c of the first intermediate image, neighboring pixels, and the pixel c of the reprojected image.

To effectively remove noise, greater weights may need to be assigned to pixels with similar features. For this purpose, similarity-based weights and the first intermediate image may be used on a left side of Equation 14. A right side of Equation 14 may utilize the reprojected image and bandwidth parameters representing a mixing ratio.

Although omitted from this disclosure, it is apparent to those skilled in the art that a weight

$$( e . g . , {m}_{i}^{B} )$$

corresponding to the second image may be determined, and the second output image

$$( e . g . , \hat{f} ( {x}_{c}^{B} ) )$$

may be generated in the same manner as the method of generating the first output image described above.

The electronic device may generate a target image (e.g., \hat{ƒ}(x_{c})), which is a final output, by combining the first output image with the second output image. The electronic device may generate \hat{ƒ}(x_{c}) based on Equation 15.

$$\hat{f} ( {x}_{c} ) = \frac{\hat{f} ( {x}_{c}^{A} ) {\sum }_{i ∈ {Ω}_{c}^{′}} {m}_{i}^{A} + \hat{f} ( {x}_{c}^{B} ) {\sum }_{i ∈ {Ω}_{c}^{′}} {m}_{i}^{B}}{{\sum }_{i ∈ {Ω}_{c}^{′}} {m}_{i}^{A} + {\sum }_{i ∈ {Ω}_{c}^{′}} {m}_{i}^{B}} \qquad [ Equation 15 ]$$

The operations described above may be performed for each of a plurality of windows.

The target image may be the final output image of the current frame with noise removed. The target image may be displayed on a screen as the output image for the current frame.

The first intermediate image and the second intermediate image generated through cross regression may include some noise and are minimally biased images that may be used as label images for training an artificial neural network.

Hereinafter, a method of training an artificial neural network according to an embodiment is described.

FIG. 6 illustrates a flowchart illustrating training of an artificial neural network according to an embodiment. In the following embodiments, operations may be performed sequentially but not necessarily. For example, the order of the operations may be changed, and at least two of the operations may be performed in parallel. According to an embodiment, at least two operations may be merged, an operation may be divided, a specific operation may not be performed, and/or another operation may be additionally included. According to an embodiment, when instructions stored in memory are executed individually and/or collectively by at least one processor, operations 610 and 620 may be performed by an electronic device.

In operation 610, the electronic device may determine a loss function of the artificial neural network.

The electronic device may determine the loss function (e.g., [symbol] ) as shown in Equation 16.

$$ℒ = \frac{1}{\vert ℐ \vert} {\sum }_{c ∈ ℐ} \frac{1}{2} ( {ℒ}_{c}^{2} + {ℒ}_{c}^{t} ) \qquad [ Equation 16 ]$$

I may represent a set of all pixels. Herein, a filter may include a spatiotemporal filter. Therefore, the loss function may be expressed as a spatial loss

$$( e . g . , {ℒ}_{c}^{s} )$$

and a temporal loss

$$( e . g . , {ℒ}_{c}^{t} )$$

at a pixel c.

The spatial loss may represent a loss in the same frame. For example, the spatial loss may indicate a loss in the current frame. Since the spatial loss represents the loss in the same frame, images generated from the same frame may be used. The electronic device may determine the spatial loss based on the first output image

$$( e . g . , \hat{f} ( {x}_{c}^{A} ) ) ,$$

the second output image

$$( e . g . , \hat{f} ( {x}_{c}^{B} ) ) ,$$

the first intermediate image (e.g., \tilde{ƒ}(x^{A})), and the second intermediate image (e.g., \tilde{ƒ}(x^{B})). The spatial loss may be expressed by the equation below.

$${ℒ}_{c}^{s} = \frac{1}{2} ( \frac{{‖ \hat{f} ( {x}_{c}^{A} ) - \tilde{f} ( {x}_{c}^{B} ) ‖}^{2}}{{‖ \tilde{f} ( {x}_{c}^{B} ) ‖}^{2} + ϵ} + \frac{{‖ \hat{f} ( {x}_{c}^{B} ) - \tilde{f} ( {x}_{c}^{A} ) ‖}^{2}}{{‖ \tilde{f} ( {x}_{c}^{A} ) ‖}^{2} + ϵ} ) \qquad [ Equation 17 ]$$

The spatial loss may be determined by crossing the first intermediate image generated from the first image with the first output image and crossing the second intermediate image generated from the second image with the second output image. To determine the spatial loss, the error between the first output image and the second intermediate image and the error between the second output image and the first intermediate image may be used.

The temporal loss may be a loss between different frames. For example, the temporal loss may be a loss between the current frame and the previous frame. Since the temporal loss is the loss between different frames, e.g., the current frame and the previous frame, images generated in the current frame and the previous frame may be used. For the image generated in the previous frame, an image reprojected from a view point of the current frame may be used. The electronic device may calculate the temporal loss based on the first output image

$$( e . g . , \hat{f} ( {x}_{c}^{A} ) )$$

and the second output image

$$( e . g . , \hat{f} ( {x}_{c}^{B} ) )$$

of the current frame, as well as a reprojected first intermediate image

$$( e . g . , ℛ {\tilde{f}}^{p} ( {x}_{c}^{A} ) )$$

and a reprojected second intermediate image

$$( e . g . , ℛ {\tilde{f}}^{p} ( {x}_{c}^{B} ) ) ,$$

which are generated by reprojecting intermediate images obtained from cross regression of the previous frame from the view point of the current frame. The temporal loss may be expressed by Equation 18 below.

$${ℒ}_{c}^{t} = \frac{1}{2} ( \frac{{‖ \hat{f} ( {x}_{c}^{A} ) - ℛ {\tilde{f}}^{p} ( {x}_{c}^{B} ) ‖}^{2}}{{‖ ℛ {\tilde{f}}^{p} ( {x}_{c}^{B} ) ‖}^{2} + ϵ} + \frac{{‖ \hat{f} ( {x}_{c}^{B} ) - ℛ {\tilde{f}}^{p} ( {x}_{c}^{A} ) ‖}^{2}}{{‖ ℛ {\tilde{f}}^{p} ( {x}_{c}^{A} ) ‖}^{2} + ϵ} ) \qquad [ Equation 18 ]$$

The temporal loss may be determined by crossing images (e.g., the first output image and the reprojected first intermediate image) corresponding to the first image and images (e.g., the second output image and the reprojected second intermediate image) corresponding to the second image. To determine the temporal loss, the error between the first output image and the reprojected second intermediate image and the error between the second output image and the reprojected first intermediate image may be used.

In operation 620, the electronic device may update the artificial neural network based on the loss function.

The electronic device may train the artificial neural network by backpropagating the loss function determined based on the spatial loss and temporal loss. Since the artificial neural network is trained while rendering an image sequence, this training may be referred to as real-time training. The artificial neural network trained in the current frame may be used for the next frame.

Hereinafter, a relationship between consecutive frames is described.

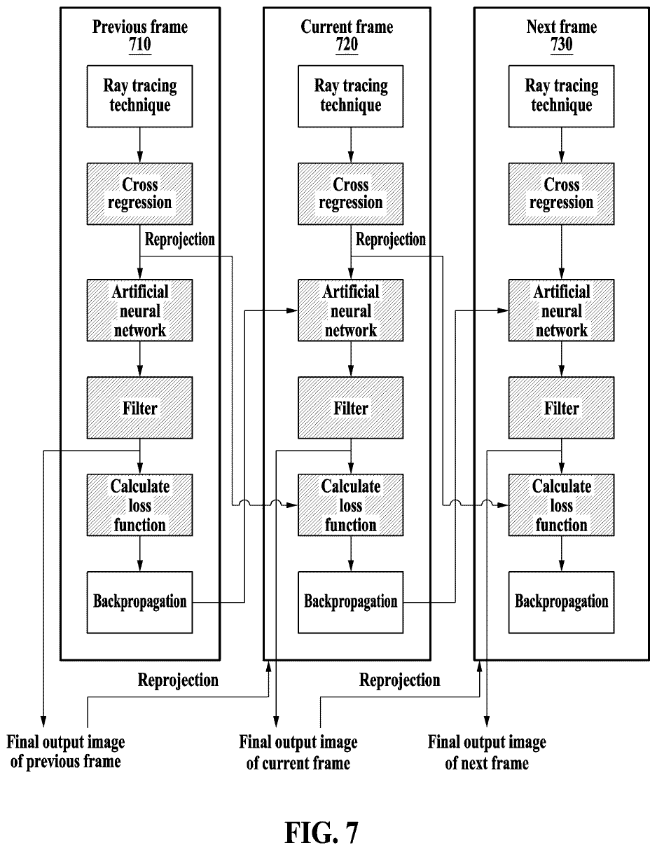

FIG. 7 is a diagram illustrating a connection relationship between frames according to an embodiment.

FIG. 7 illustrates a previous frame 710, a current frame 720, and a next frame 730. The previous frame 710, the current frame 720, and the next frame 730 may be consecutive frames.

In each frame, the operations described with reference to FIGS. 1 to 6 may be performed. For example, in each frame, intermediate image generation through cross regression, determination of bandwidth parameters through an artificial neural network, output image generation through a filter, loss function determination, and update of the artificial neural network through backpropagation may be performed.

A final output image (e.g., a target image) of the previous frame 710 may be reprojected from a view point of the current frame 720 and input to the artificial neural network and the filter in the current frame 720. A final output image (e.g., a target image) of the current frame 720 may be reprojected from a view point of the next frame 730 and input to the artificial neural network and the filter in the next frame 730.

Intermediate images generated based on cross regression of the previous frame 710 may be reprojected from the view point of the current frame 720 and used for error calculation in the current frame 720. Intermediate images generated based on cross regression of the current frame 720 may be reprojected from the view point of the next frame 730 and used for error calculation in the next frame 730.

The artificial neural network updated through backpropagation in the previous frame 710 may be used in the current frame 720. The artificial neural network updated through backpropagation in the current frame 720 may be used in the next frame 730.

As described above, consecutive frames may be interconnected.

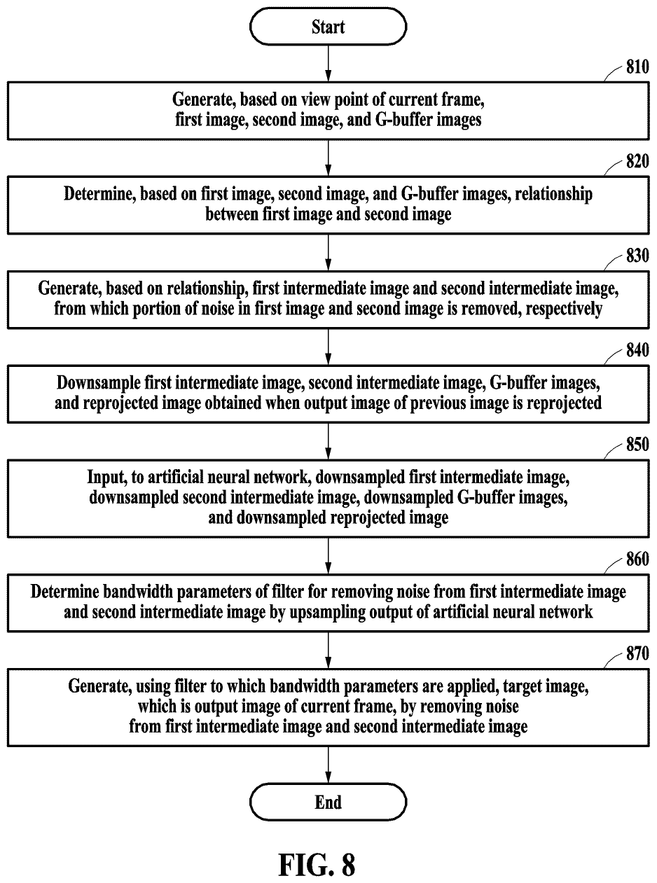

FIG. 8 is a flowchart illustrating operations of an electronic device according to an embodiment.

In the following embodiments, operations may be performed sequentially but not necessarily. For example, the order of the operations may be changed, and at least two of the operations may be performed in parallel. According to an embodiment, at least two operations may be merged, an operation may be divided, a specific operation may not be performed, and/or another operation may be additionally included. According to an embodiment, when instructions stored in memory are executed individually and/or collectively by at least one processor, operations 810 to 870 may be performed by the electronic device.

In operation 810, the electronic device may generate, based on a view point of a current frame, a first image, a second image, and G-buffer images.

In operation 820, the electronic device may determine, based on the first image, the second image, and the G-buffer images, a relationship between the first image and the second image, and the relationship may be expressed linearly.

In operation 830, the electronic device may generate, based on the relationship, a first intermediate image and a second intermediate image, from which a portion of noise in the first image and the second image is removed, respectively.

In operation 840, the electronic device may downsample the first intermediate image, the second intermediate image, the G-buffer images, and a reprojected image obtained when an output image of a previous frame (e.g., an immediately preceding frame) of the current frame to input, to an artificial neural network, the first intermediate image, the second intermediate image, the G-buffer images, and the reprojected image.

In operation 850, the electronic device may input, to the artificial neural network, the downsampled first intermediate image, the downsampled second intermediate image, the downsampled G-buffer images, and the downsampled reprojected image.

In operation 860, the electronic device may determine bandwidth parameters of a filter for removing noise from the first intermediate image and the second intermediate image by upsampling an output of the artificial neural network.

In operation 870, the electronic device may generate, using the filter to which the bandwidth parameters are applied, a target image, which is an output image of the current frame, by removing noise from the first intermediate image and the second intermediate image.

Descriptions provided with reference to FIGS. 1 to 7 may be applied to operations 810 to 870, and thus, detailed descriptions of operations 810 to 870 are omitted.

The embodiments described herein may be implemented using a hardware component, a software component, and/or a combination thereof. A processing device may be implemented using one or more general-purpose or special-purpose computers, such as, for example but not limited to, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device may also access, store, manipulate, process, and/or generate data in response to execution of the software. For purpose of simplicity, the description of the processing device is used as singular; however, one skilled in the art will appreciate that the processing device may include a plurality of processing elements and/or multiple types of processing elements. For example, the processing device may include a plurality of processors or a single processor and a single controller. In addition, different processing configurations are possible, such as parallel processors.

The software may include a computer program, a piece of code, an instruction, or one or more combinations thereof, to independently or collectively instruct or configure the processing device to operate as desired. Software and data may be stored in any type of machine, component, physical or virtual equipment, or computer storage medium or device capable of providing instructions or data to or being interpreted by the processing unit. The software may also be distributed over network-coupled computer systems so that the software is stored and executed in a distributed fashion. The software and data may be stored in a non-transitory computer-readable recording medium.

The methods according to the above-described embodiments may be recorded in a non-transitory computer-readable medium including program instructions to implement various operations of the above-described embodiments. The medium may also include, alone or in combination with the program instructions, data files, data structures, and the like. The program instructions recorded on the medium may be those specially designed and constructed for the purposes of examples, or they may be of the kind well-known and available to those having skill in the computer software arts. Examples of the non-transitory computer-readable medium include magnetic media such as hard disks, floppy disks, and magnetic tape; optical media such as compact disc read-only memory (CD-ROM) discs and/or digital versatile discs (DVDs); magneto-optical media such as optical discs; and hardware devices that are specially configured to store and perform program instructions, such as ROM, random access memory (RAM), flash memory, and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the example embodiments have been described with reference to the limited drawings, a person skilled in the art may apply various technical modifications and variations based thereon. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

What is claimed is:

1. An operation method of an electronic device, the operation method comprising:
generating, based on a view point of a current frame, a first image, a second image, and at least one geometry (G)-buffer image;
determining, based on the first image, the second image, and the at least one G-buffer image, a relationship between the first image and the second image;
generating, based on the relationship, a first intermediate image and a second intermediate image, from which a portion of a noise in the first image and the second image is removed, respectively;
determining bandwidth parameters of a filter for removing a noise from the first intermediate image and the second intermediate image by inputting, to an artificial neural network, the first intermediate image, the second intermediate image, the at least one G-buffer image, and a reprojected image obtained when an output image of a previous frame of the current frame is reprojected from the view point of the current frame; and
generating a target image, which is an output image of the current frame, by removing the noise from the first intermediate image and the second intermediate image using the filter to which the bandwidth parameters are applied.

2. The operation method of claim 1, wherein the determining the relationship comprises determining a first relationship between a pixel value of the first image and pixel variables of the second image and determining a second relationship between a pixel value of the second image and pixel variables of the first image.

3. The operation method of claim 2, wherein the first relationship and the second relationship are expressed linearly.

4. The operation method of claim 1, wherein the first image and the at least one G-buffer image are images generated from the view point of the current frame, and
wherein the second image is an image generated from the view point of the current frame or a view point of the previous frame.

5. The operation method of claim 1, wherein the determining the bandwidth parameters comprises:
downsampling the first intermediate image, the second intermediate image, the at least one G-buffer image, and the reprojected image and inputting, to the artificial neural network, the downsampled first intermediate image, the downsampled second intermediate image, the downsampled at least one G-buffer image, and the downsampled reprojected image; and
obtaining a bandwidth parameter per pixel of the filter by upsampling an output of the artificial neural network.

6. The operation method of claim 1, wherein the determining the relationship comprises setting a plurality of windows for the first image, the second image, and the at least one G-buffer image and determining the relationship between the first image and the second image for each of the plurality of windows.

7. The operation method of claim 1, wherein the generating the target image comprises generating the target image by combining a first output image, obtained by applying a first filter to the first intermediate image, with a second output image, obtained by applying a second filter to the second intermediate image,
wherein the first filter is determined by applying a bandwidth parameter related to the first intermediate image among the bandwidth parameters to the filter, and
wherein the second filter is determined by applying a bandwidth parameter related to the second intermediate image among the bandwidth parameters to the filter.

8. The operation method of claim 1, further comprising:
determining a loss function of the artificial neural network; and
updating the artificial neural network based on the loss function.

9. The operation method of claim 8, wherein the updated artificial neural network is used to determine bandwidth parameters of the filter for removing a noise from a next frame of the current frame.

10. An operation method of an electronic device, the operation method comprising:
generating, based on a view point of a current frame, a first image, a second image, and a geometry (G)-buffer image;
determining, based on the first image, the second image, and the at least one G-buffer image, a relationship between the first image and the second image, wherein the relationship is expressed linearly;
generating, based on the relationship, a first intermediate image and a second intermediate image, from which a portion of a noise in the first image and the second image is removed, respectively;
downsampling the first intermediate image, the second intermediate image, the at least one G-buffer image, and a reprojected image obtained when an output image of a previous frame of the current frame is reprojected from the view point of the current frame;
inputting, to an artificial neural network, the downsampled first intermediate image, the downsampled second intermediate image, the downsampled at least one G-buffer image, and the downsampled reprojected image;
determining bandwidth parameters of a filter for removing a noise from the first intermediate image and the second intermediate image by upsampling an output of the artificial neural network; and
generating a target image, which is an output image of the current frame, by removing the noise from the first intermediate image and the second intermediate image using the filter to which the bandwidth parameters are applied.

11. The operation method of claim 10, wherein the first image and the at least one G-buffer image are images generated from the view point of the current frame, and
wherein the second image is an image generated from the view point of the current frame or a view point of the previous frame.

12. An electronic device comprising:
memory comprising instructions; and
at least one processor configured to execute the instructions,
wherein the instructions, when executed individually and/or collectively by the at least one processor, cause the electronic device to:
generate, based on a view point of a current frame, a first image, a second image, and at least one geometry (G)-buffer image;
determine, based on the first image, the second image, and the at least one G-buffer image, a relationship between the first image and the second image;
generate, based on the relationship, a first intermediate image and a second intermediate image, from which a portion of a noise in the first image and the second image is removed, respectively;
determine bandwidth parameters of a filter for removing a noise from the first intermediate image and the second intermediate image by inputting, to an artificial neural network, the first intermediate image, the second intermediate image, the at least one G-buffer image, and a reprojected image obtained when an output image of a previous frame of the current frame is reprojected from the view point of the current frame; and
generate a target image, which is an output image of the current frame, by removing the noise from the first intermediate image and the second intermediate image using the filter to which the bandwidth parameters are applied.

13. The electronic device of claim 12, wherein the instructions, when executed individually and/or collectively by the at least one processor, cause the electronic device to determine a first relationship between a pixel value of the first image and pixel variables of the second image and determine a second relationship between a pixel value of the second image and pixel variables of the first image.

14. The electronic device of claim 13, wherein the first relationship and the second relationship are expressed linearly.

15. The electronic device of claim 12, wherein the first image and the at least one G-buffer image are images generated from the view point of the current frame, and
wherein the second image is an image generated from a view point of the current frame or a view point of the previous frame.

16. The electronic device of claim 12, wherein the instructions, when executed individually and/or collectively by the at least one processor, cause the electronic device to:
downsample the first intermediate image, the second intermediate image, the at least one G-buffer image, and the reprojected image and input, to the artificial neural network, the donwsampled first intermediate image, the downsampled second intermediate image, the downsampled at least one G-buffer image, and the downsampled reprojected image; and
obtain a bandwidth parameter per pixel of the filter by upsampling an output of the artificial neural network.

17. The electronic device of claim 12, wherein the instructions, when executed individually and/or collectively by the at least one processor, cause the electronic device to set a plurality of windows for the first image, the second image, and the at least one G-buffer image and determine the relationship between the first image and the second image for each of the plurality of windows.

18. The electronic device of claim 12, wherein the instructions, when executed individually and/or collectively by the at least one processor, cause the electronic device to generate the target image by combining a first output image, obtained by applying a first filter to the first intermediate image, with a second output image, obtained by applying a second filter to the second intermediate image,
wherein the first filter is determined by applying a bandwidth parameter related to the first intermediate image among the bandwidth parameters to the filter, and
wherein the second filter is determined by applying a bandwidth parameter related to the second intermediate image among the bandwidth parameters to the filter.

19. The electronic device of claim 12, wherein the instructions, when executed individually and/or collectively by the at least one processor, cause the electronic device to:
determine a loss function of the artificial neural network; and
update the artificial neural network based on the loss function.

20. The electronic device of claim 19, wherein the updated artificial neural network is used to determine bandwidth parameters of the filter for removing a noise from a next frame of the current frame.
